(19) United States
(12) Patent Application Publication
(10) Pub. No.: US 2011/0060806 A1
(43) Pub. Date: Mar. 10, 2011

(54) USING IN-THE-CLOUD STORAGE FOR COMPUTER HEALTH DATA

(75) Inventors: Christopher Boscolo, Bellevue, WA (US); Matthew Higgins, Seattle, WA (US); Paul Forgey, Seattle, WA (US); Jon Gross, Seattle, WA (US)

(73) Assignee: Napera Networks

(21) Appl. No.: 12/751,965

(22) Filed: Mar. 31, 2010

Related U.S. Application Data
(60) Provisional application No. 61/165,445, filed on Mar. 31, 2009.

(51) Int. Cl. G06F 15/173; G06F 15/167

(52) U.S. Cl. 709/213; 709/224

(57) ABSTRACT

A policy enforcement point (PEP) controls access to a network in accordance with one or more policy statements that specify conditions for compliant devices. The PEP receives current health data from a device seeking to access the network, and stores this health data in local volatile memory. If the health data stored in local volatile memory complies with the policy statements, the device is permitted to access the network. Otherwise, the device is denied access to the network, or permitted only limited access to the network in order to resolve its compliance issues. The PEP occasionally stores the health data in local persistent memory and on an online service (OLS). During reboot, the PEP accesses the OLS to confirm that it has the most recent health data. If more recent health data is available from the OLS, the OLS provides this more recent data to the PEP.

### CROSS-REFERENCE TO RELATED APPLICATION(S)

This application claims priority to and incorporates by reference in its entirety U.S. Provisional Patent Application No. 61/165,445, entitled USING IN-THE-CLOUD STORAGE FOR COMPUTER HEALTH DATA, filed on Mar. 31, 2009.

### BACKGROUND

A network access control (NAC) device is used to limit a computer's access to a network in accordance with one or more administrator-defined policies. These policies may include, for example, limiting the types of protocols, network services, servers, or other network devices that a connected computer is permitted to access.

A conventional NAC device determines whether and how to enforce network access control based on information provided to the NAC device by connected computers. An example of such network access control is user-based authentication—the NAC device may only allow full network access if a user of a connecting device has authenticated to the network and has the appropriate access privileges.

### BRIEF DESCRIPTION OF THE DRAWINGS

FIG. 1 is a block diagram of an environment in which aspects of the described technology may operate.

FIG. 2 is a flow diagram of a process for storing device health data in local persistent memory and on an online service.

FIG. 3 is a block diagram of a snapshot data structure for storing device health data.

FIG. 4 is a flow diagram of a process for initializing a policy enforcement point.

### DETAILED DESCRIPTION

In most networks, several different components work together to determine the level of access that should be granted to a computer. A wired (e.g., Ethernet) switch or wireless access point typically provides a bridge between the computer and these components, providing or denying access to the computer. These access points generally operate in an unsophisticated manner, simply enforcing access permissions provided by a policy server, by either using access control lists (ACLs) or assigning computers to certain virtual local area networks (VLANs). Access points generally have a limited amount of persistent storage, usually in the form of slower flash memories. Most access points do not have hard disk memory. Accordingly, methods and systems for controlling access to a network without relying exclusively on the persistent storage capabilities of access points are desired.

To address these and other drawbacks in existing networks, methods and systems for using inthe-cloud storage for computer health data are described herein. A policy enforcement point (PEP) controls access to a network in accordance with one or more policy statements that specify conditions for compliant devices. When a device attempts to gain access to a network controlled by the PEP, the PEP interrogates the device to obtain current health data. This health data may include an anti-virus protection level, system update version, and/or configuration. In some cases, software running on the device performs the interrogation and provides health data to the PEP. If the current health data complies with the policy statements, the device is permitted to access the network. Otherwise, the device is denied access to the network, or permitted only limited access to the network in order to resolve its compliance issues. For example, the out-of-compliance device may be permitted to access a certain set of network servers in order to resolve its compliance issues. Once the device is in compliance with the policy statements, it is permitted to access the network.

When the PEP receives current health data from a device, the PEP stores this health data in local volatile memory. The PEP uses the data stored in local volatile memory to control access to the network in accordance with the policy statements. However, because information stored in volatile memory is lost when power to the memory is lost, the PEP occasionally stores the health data in local persistent memory. In addition, to reduce the number of times the PEP must write to local persistent memory while nonetheless preserving the consistency of information against an unplanned reboot, the PEP stores the collected health data on an online service (OLS). During reboot, the PEP accesses the OLS to confirm that it has the most recent health data. If more recent health data is available from the OLS, the OLS provides this more recent data to the PEP.

Various embodiments of the technology will now be described. The following description provides specific details for a thorough understanding and an enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the technology.

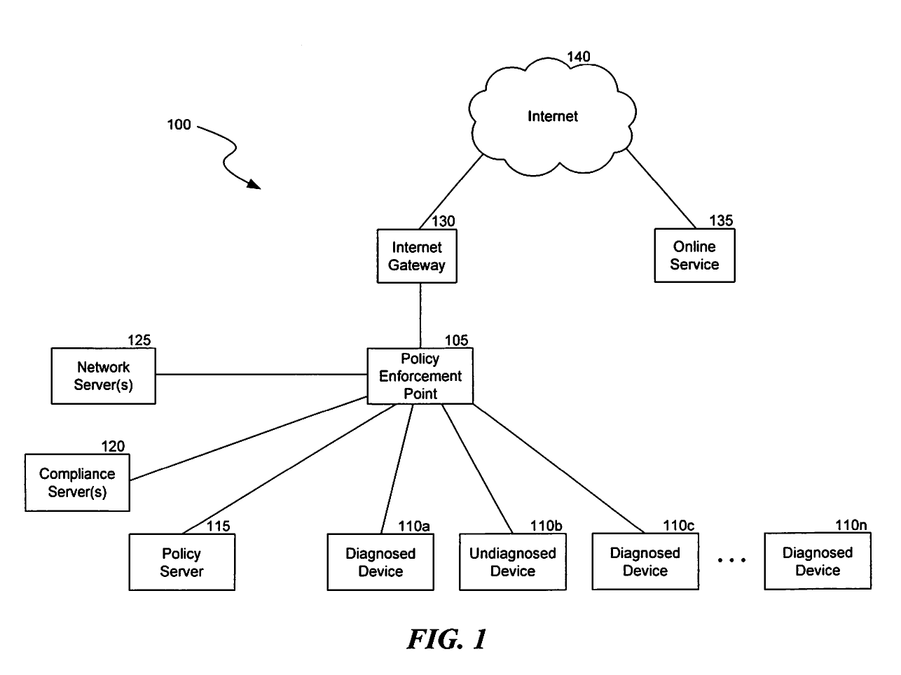

FIG. 1 is a block diagram of an environment 100 in which aspects of the technology described herein may operate. A policy enforcement point (PEP) 105 controls access to a network comprising one or more network servers 125, one or more compliance servers 120, and one or more devices 110a-110n. The PEP 105 is a health-specific appliance, a generalized network access control (NAC) appliance, or other networking element that includes health NAC functionality, such as a network switch or proxy server. In some embodiments, the PEP 105 comprises both volatile and persistent memory. Volatile memory may include any type of tangible computer-readable media, including static or dynamic random access memory (SRAM or DRAM) and/or other types of volatile computer-readable media. Persistent memory may include any type of tangible computer-readable media, including flash memory, read-only memory (ROM), magnetic computer storage devices (e.g., hard disks), optical discs, and/or other types of persistent computer-readable media.

The PEP 105 receives policy data from a policy server 115. Policy data comprises one or more administrator-defined policy statements that specify conditions with which a device must comply in order to gain access to the network controlled by the PEP 105. For example, a policy statement may specify an anti-virus protection level, a system update version, a device configuration, and/or other parameter associated with a device. If a device does not comply with the policy statements associated with the network, the device is denied access to the network, or permitted only limited access to the network in order to resolve its compliance issues. Once the device is in compliance with the policy statements, it is permitted to access the network.

The PEP 105 is coupled to devices 110a-n seeking to access the network. In some embodiments, a device 110 is a computer system comprising a processor and memory. In some embodiments, this computer system is a network host that is coupled to one or more additional computer systems seeking to access the network. Although not required, aspects of the technology may be described herein in the general context of computer-executable instructions, such as routines executed by a general or special purpose data processing device (e.g., a server or client computer). Those skilled in the art will appreciate that the described technology can be practiced with other computer system configurations, including mobile devices, Internet appliances, multi-processor systems, mainframe computers, and/or other computer system configurations. Alternatively or additionally, the described technology can be embodied in a special purpose computer or data processor that is specifically programmed, configured, and/or constructed to perform one or more of the computer-executable instructions described herein.

Alternatively or additionally, computer implemented instructions, data structures and other data related to the technology may be distributed over the Internet or other network, on a propagated signal on a propagation medium (e.g., an electromagnetic wave(s), a sound wave, etc.) over a period of time. In some implementations, the data may be provided on any analog or digital network (e.g., a packet switched, circuit switched, or other network scheme) and its contingent components, such as routers, switches, radio or optical transceivers or receivers, etc.

The described technology can also be practiced in distributed computing environments, where tasks or modules are performed by remote processing devices, which are linked through a communications network, such as a LAN, WAN, the Internet, or other communications network. In a distributed computing environment, program modules or sub-routines may be located in both local and remote memory storage devices. In addition, those skilled in the art will recognize that portions of the described technology may reside on a server computer, while corresponding portions reside on a client computer.

Returning to FIG. 1, the PEP 105 receives current health data from the devices 110 seeking to access the network. Health data may include an anti-virus protection level, a system update version, a device configuration, and/or other parameter associated with the device 110. Devices 110 may include diagnosed devices 110a, 110b, and 110n for which the PEP 105 has determined network access levels, and undiagnosed devices 110b for which the PEP has not determined network access levels.

If the current health data submitted by a device 110 complies with the policy data defined by the policy server 115, the device 110 is permitted to access the network controlled by the PEP 105. In some embodiments, device 110 is permitted to access the entire network controlled by the PEP 105, while in other embodiments, the device is permitted to access only a certain portion of the network. For example, based on a particular device 110 parameter (e.g., anti-virus protection level), the device may be permitted to access certain network servers 125 and/or other devices 110, while it is denied access to certain other network servers and/or other devices.

If the current health data submitted by the device 110 does not comply with the policy statements defined by the policy server 115, the device may be denied access to the network controlled by the PEP 105. Alternatively, the device 110 may be permitted to access one or more compliance servers 120 in order to resolve its compliance issues. For example, a compliance server 120 may provide the device 110 with an anti-virus update, system update, and/or other component required to comply with the policy statements defined by the policy server 115. Once the device 110 is in compliance, it is permitted to access the network controlled by the PEP 105.

The PEP 105 provides the policy and health data it collects to an online service (OLS) 135 via an Internet gateway 130 coupled to the Internet 140. While the Internet 140 is depicted in the illustrated embodiment, one skilled in the art will appreciate that a variety of other networks may be used, including a wide area network (WAN) or a local area network (LAN). The OLS 135 groups and persistently stores the policy and health data provided by the PEP 105.

In some embodiments, a device 110 may provide its current health data directly to the OLS 135. For example, if the device's 110 connection to the PEP 105 is disabled, but the device is still connected to the Internet, the device 110 may directly communicate with the OLS 135. For instance, if a user takes his or her laptop computer to an Internet café, the computer may provide current health data to the OLS 135 via a cell network card coupled to the computer. When the device 110 is reconnected to the PEP 105, the PEP may permit or deny the device access to the network based on the health data received by the OLS 135.

As described above, the PEP 105 receives current health data from one or more devices 110. When the current health data is received, the PEP stores this data in local volatile memory. The PEP 105 uses the data stored in local volatile memory to control access to the network in accordance with the policy data received from the policy server. However, information stored in volatile memory is lost when power to the memory is lost. Accordingly, the PEP 105 occasionally stores the health data in local persistent memory, which retains stored information even when power to the memory is lost. This pattern of data storage is well suited for flash-based persistent memory, where the number of available write cycles is limited. In addition, because the persistent memory capabilities of the PEP 105 may be limited, the PEP also stores the health data on the OLS 135. Such storage of health data allows the PEP 105 to maintain a consistent policy application after the PEP is rebooted.

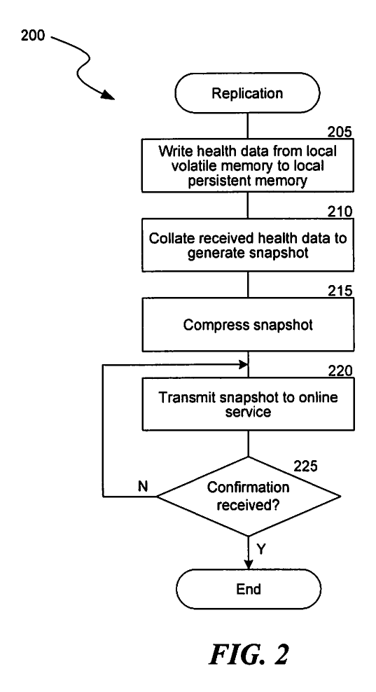

FIG. 2 is a flow diagram of a process 200 by which the PEP 105 stores health data on local persistent memory and the OLS 135 in accordance with embodiments of the described technology. At a block 205, the PEP 105 writes the health data stored in local volatile memory to local persistent memory. In some embodiments, the PEP 105 writes this health data to local persistent memory on a periodic basis, such as once per given time period (e.g., number of days or hours). Alternatively or additionally, the PEP 105 writes the health data to local persistent memory upon a planned shutdown or reboot of the PEP, along with the timestamp of the most recent health data received from the OLS 135, as described in additional detail herein.

As described above, in some embodiments, the PEP 105 uses flash-based persistent memory. Flash-based persistent memory can only be written a finite number of times before it ceases to function. Accordingly, in such embodiments, the PEP 105 may write the health data to its persistent memory in a manner that preserves the ability to use the persistent memory for the operational lifetime of the PEP, such as once per day or other time period.

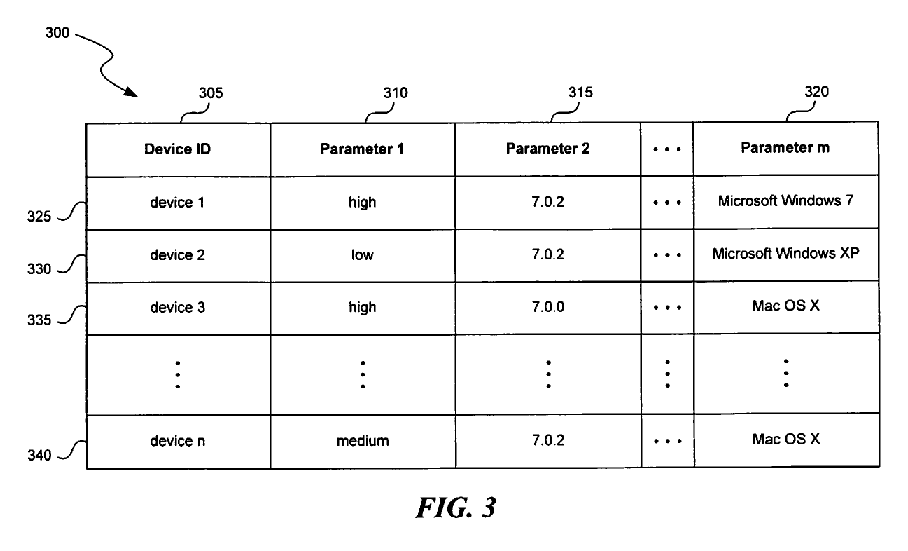

At a block 210, the PEP 105 collates the received health data in local persistent memory to generate a snapshot. FIG. 3 is a block diagram of a suitable snapshot data structure 300. The data structure 300 includes a device identifier (ID) column 305 comprising indications of devices for which current health data have been received. In some embodiments, the device ID is a unique alphanumeric string that identifies the associated device. The data structure 300 also includes columns 310-320 corresponding to device health data parameters 1-m. For example, column 310 may correspond to an anti-virus protection level; column 315 to a system update version; and column 320 to a device operating system. These parameters are provided for illustrative purposes only, and are not intended to limit the described technology. Records 325-340 are generated for each device for which the PEP 105 has received current health data.

Returning to FIG. 2, at a block 215, the PEP 105 compresses the generated snapshot according to at least one well known compression and/or encryption algorithm. At a block 220, the PEP 105 transmits the compressed snapshot to the OLS 135 via a reliable Internet or other network protocol. In some embodiments, the PEP 105 transmits the snapshot to the OLS 135 on a periodic basis, such as once per given time period (e.g., number of days or hours). Alternatively or additionally, each time the health data received from a device 110 changes, the PEP 105 sends an indication of this change to the OLS 135.

When the snapshot is received by the OLS, it sends a confirmation message to the PEP 105 indicating that the transmission was received successfully. At a block 225, the PEP 105 determines whether it has received confirmation from the OLS 135. If so, the process 200 ends. Otherwise, the process 200 returns to block 220, where the PEP 105 retransmits the snapshot until a transmission confirmation is received from the OLS 135.

As described above, when the PEP 105 undergoes a planned shutdown or reboot, the PEP writes the current health data stored in local volatile memory to local persistent memory. A planned reboot is performed in accordance with a normal operating process of the PEP 105. However, the PEP 105 may also be shut down or rebooted in an unplanned manner. An unplanned reboot may be caused by a power failure, software bug, and/or other event outside of the normal operating process of the PEP. In order to preserve the consistency of information against an unplanned reboot, while reducing the number of times the PEP 105 must write to local persistent memory, among other benefits, the PEP stores the collected health data on the OLS 135, as described above.

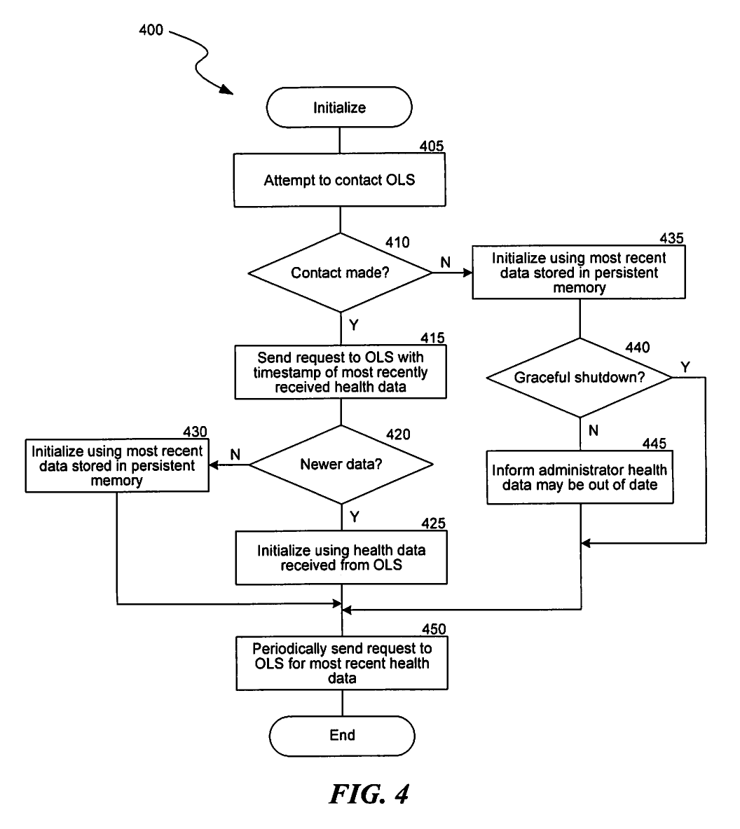

FIG. 4 is a flow diagram of a process by which the PEP 105 initializes after a planned or unplanned reboot in accordance with some embodiments of the described technology. At a block 405, the PEP 105 attempts to contact the OLS 135. In various embodiments, the PEP 105 automatically contacting the OLS 135, or presents an administrator with an option to contact the OLS to download the most recent snapshot from the OLS.

At a decision block 410, the PEP 105 determines whether contact is made with the OLS 135. If so, at a block 415 the PEP 105 sends a request to the OLS 135 along with the timestamp of the most recent health data received from the OLS. The OLS 135 compares the received timestamp with a timestamp associated with the most recent health data stored by the OLS. If the OLS 135 contains more recent health data, it sends this more recent data to the PEP 105.

At a block 420, the PEP 105 determines whether more recent health data was received from the OLS 135. If more recent health data was received, at a block 425, the PEP 105 initializes with this more recent data. Otherwise, at a block 430, the PEP 105 initializes using the most recent information stored in local persistent memory. Initialization comprises storing the most recent health data in local persistent memory and local volatile memory. The PEP 105 is then operated in accordance with the data stored in local volatile memory.

If at decision block 410 contact was not made with the OLS 135, at a block 435, the PEP 105 initializes using the most recent information stored in local persistent memory. Because contact was not made with the OLS 135, the PEP 105 is not able to confirm that it has the most recent health data. Accordingly, at a decision block 440, the PEP 105 determines whether the PEP was shut down gracefully (i.e., in a planned manner) prior to the reboot, and thus stored the current health data according to normal operating procedure. For example, a stored flag may indicate whether the PEP 105 was shut down gracefully. If the PEP 105 was not shut down gracefully, at a block 445, the PEP 105 informs an administrator that the health data may be out of date.

In addition to requesting the most recent health data from the OLS 135 at initialization, in some embodiments the PEP 105 requests the most recent health data from the OLS during operation. At a block 450, the PEP 105 periodically sends a request to the OLS 135 for the most recent health data. The OLS 135 sends the most recent health data to the PEP 105 along with a timestamp associated with that version of the health data. Among other benefits, requesting the most recent health data from the OLS 135 during operation allows the PEP 105 to ensure it is operating with the most recent data, especially if the PEP was unable to make contact with the OLS during initialization. In addition, the PEP 105 ensures that it has the most recent data for a device that is connected to the PEP after being connected to the OLS 135 directly via the internet or via another PEP. Moreover, in some embodiments, if a device cannot and/or does not communicate its current health data to the PEP 105 upon connection to the PEP, the PEP uses the most recent heath data provided to the OLS 135 directly via the Internet or via another PEP.

From the foregoing, it will be appreciated that specific embodiments of the technology have been described herein for purposes of illustration, but that various modifications may be made without deviating from the spirit and scope of the technology. For example, while FIG. 3 depicts a table whose contents and organization are designed to make them more comprehensible by a human reader, those skilled in the art will appreciate that the actual data structure(s) used by the system to store this information may differ from the table shown, in that they, for example, may be organized in a different manner, may contain more or less information than shown, may be compressed and/or encrypted, and may be optimized in a variety of ways. Those skilled in the art will further appreciate that the depicted flow charts may be altered in a variety of ways. For example, the order of the steps may be rearranged, steps may be performed in parallel, steps may be omitted, or other steps may be included. Accordingly, the described technology is not limited except as by the appended claims.

I/We claim:

1. A method in a computing system for maintaining computer health state in connection with a policy enforcement point device, the policy enforcement point device having both local volatile memory and local persistent memory, the method comprising:
in the policy enforcement point device, receiving a stream of computer health information reports, each received computer health information report being from a network host that is attached to a network to which the policy enforcement point device is attached and indicating the computer health status of that network host;
in response to receiving each computer health information report, incorporating information from the received computer health information report into a computer health state stored in local volatile memory;
operating the policy enforcement point device in accordance with the computer health state stored in local volatile memory;
with a first average frequency, updating a computer health state stored in local persistent memory to be consistent with the computer health state stored in local volatile memory; and
with a second average frequency that is at least two times as large as the first average frequency, updating a computer health state maintained by a remote online service to be consistent with the computer health state stored in local volatile memory.

2. The method of claim 1 wherein the second average frequency is at least three times as large as the first average frequency.

3. The method of claim 1 wherein the second average frequency is at least five times as large as the first average frequency.

4. The method of claim 1 wherein the second average frequency is at least ten times as large as the first average frequency.

5. The method of claim 1 wherein the second average frequency is at least 25 times as large as the first average frequency.

6. The method of claim 1 wherein the second average frequency is at least 50 times as large as the first average frequency.

7. The method of claim 1 wherein the second average frequency is at least 100 times as large as the first average frequency.

8. The method of claim 1 wherein the second average frequency is at least 500 times as large as the first average frequency.

9. The method of claim 1 wherein the local persistent memory is flash memory that is directly attached to the policy enforcement point device, and wherein the local volatile memory is random access memory that is directly attached to the policy enforcement point device.

10. The method of claim 1 wherein the computer health state stored in local persistent memory is updated to be consistent with the computer health state stored in local volatile memory as part of shutdown of the policy enforcement point device.

11. The method of claim 1 wherein the computer health state stored in local persistent memory is periodically updated to be consistent with the computer health state stored in local volatile memory in accordance with a prescribed period.

12. The method of claim 1 wherein the computer health state maintained by the remote online service is updated to be consistent with the computer health state stored in local volatile memory as part of shutdown of the policy enforcement point device.

13. The method of claim 1 wherein the computer health state maintained by the remote online service is periodically updated to be consistent with the computer health state stored in local volatile memory in accordance with a prescribed period.

14. The method of claim 1 wherein the computer health state maintained by the remote online service is updated to be consistent with the computer health state stored in local volatile memory in response to receiving each computer health information report.

15. The method of claim 1, further comprising, when the policy enforcement point device restarts:
reconciling the computer health state stored in local persistent memory with the computer health state maintained by the remote online service;
storing the reconciled computer health state in local volatile memory; and
operating the policy enforcement point device in accordance with the computer health state stored in local volatile memory.

16. The method of claim 1, further comprising, when the policy enforcement point device restarts:
determining that the remote online service is unavailable;
storing the computer health state stored in local persistent memory in local volatile memory; and
operating the policy enforcement point device in accordance with the computer health state stored in local volatile memory.

17. The method of claim 1 wherein a network host submits a computer health information report directly to the remote online service.

18. A computing system for maintaining computer health state, the system comprising:
a policy enforcement device comprising local volatile memory and local persistent memory, the policy enforcement device configured to:
receive current health data from at least one device coupled to the policy enforcement device;
store the received current health data in the local volatile memory;
control access of the at least one device to a network based on whether the data stored in the local volatile memory complies with one or more policy statements associated with the network;
write the data stored in the local volatile memory to the local persistent memory on a periodic basis; and
provide the data stored in the local persistent memory to a remote online service.

19. The system of claim 18 wherein the one or more policy statements are received from a policy server coupled to the policy enforcement device.

20. The system of claim 18 wherein the local persistent memory is flash memory and wherein the local volatile memory is random access memory.

21. The system of claim 18 wherein the data stored in the local volatile memory is written to the local persistent memory during shutdown of the policy enforcement device.

22. The system of claim 18 wherein the data stored in the local persistent memory is provided to the remote online service during shutdown of the policy enforcement device.

23. The system of claim 18 wherein policy enforcement device is further configured to:
reconcile data stored on the remote online service with the data stored in the local persistent memory; and
store the reconciled data in the local persistent memory and the local volatile memory.

24. A computer-readable storage medium having stored thereon instructions that, if executed by a computing system, cause the computing system to control network access by performing operations comprising:
receiving health data from at least one device coupled to the computing system, wherein the health data specifies the current health status of the at least one device;
in response to receiving the health data, storing the received health data in a local volatile memory;
controlling access to a first network based on whether the data stored in the local volatile memory complies with policy data associated with the first network;
writing the data stored in the local volatile memory to the local persistent memory on a periodic basis; and
transmitting the data stored in the local persistent memory to a remote service via a second network.

25. The computer-readable storage medium of claim 24 wherein the local persistent memory is flash memory and wherein the local volatile memory is random access memory.

26. The computer-readable storage medium of claim 24 wherein the operations further comprise:
reconciling data stored on the remote service with the data stored in the local persistent memory; and
storing the reconciled data in the local persistent memory and the local volatile memory.

27. The computer-readable storage medium of claim 24 wherein the data stored in the local volatile memory is written to the local persistent memory when the computing system is shut down according to normal operating procedure, and wherein the operations further comprise:
setting a flag in the local persistent memory that the computing system was shut down according to normal operating procedure.

28. The computer-readable storage medium of claim 27 wherein the operations further comprise:
determining whether the remote online service is available;
if the remote service is unavailable, determining whether the flag set in the local persistent memory indicates that the computing system was shut down according to normal operating procedure; and
if the flag set in the local persistent memory indicates that the computing system was not shut down according to normal operating procedure, alerting an administrator that health data may be out of date.
